(19) United States
(12) Patent Application Publication
(10) Pub. No.: US 2026/0177739 A1
(43) Pub. Date: Jun. 25, 2026

(54) SELF-CALIBRATION HIGH-TEMPERATURE-RESISTANT OPTICAL FIBER TEMPERATURE-VIBRATION DUAL-PARAMETER SENSOR

(71) Applicant: North University of China, Taiyua (CN)

(72) Inventors: Jiandong Bai, Taiyuan (CN); Yongqiu Zheng, Taiyuan (CN); Haoyan Chai, Taiyuan (CN); Yujie Han, Taiyuan (CN); Chenyang Xue, Taiyuan (CN)

(21) Appl. No.: 19/324,195

(22) Filed: Sep. 10, 2025

(30) Foreign Application Priority Data
Dec. 20, 2024 (CN) 202411885719.8

(51) Int. Cl. G02B 6/02; G01D 5/353

(52) U.S. Cl. CPC G02B 6/0218; G01D 5/35316; G01D 5/35354; G01D 5/35374

(57) ABSTRACT

A self-calibration high-temperature-resistant optical fiber temperature-vibration dual-parameter sensor includes a packaging base, a packaging cover plate, a packaging sleeve, an optical fiber, a fiber Bragg grating and a sensitive diaphragm. The packaging cover plate is fixedly connected to the packaging base, a first diaphragm groove is formed at the top of the packaging base, a second diaphragm groove is formed at the bottom of the packaging cover plate, and the first diaphragm groove and the second diaphragm groove are arranged oppositely to form a vibration space of the sensitive diaphragm; and a first Bragg grating and a second Bragg grating are arranged on the fiber Bragg grating. According to the present invention, a temperature and a vibration signal can be monitored synchronously at a high temperature, the vibration signal can be self-calibrated, and the measurement accuracy can be improved.

### CROSS-REFERENCE TO RELATED APPLICATION

This application claims priority of Chinese Patent Application No. 202411885719.8, filed on Dec. 20, 2024, the entire contents of which are incorporated herein by reference.

### TECHNICAL FIELD

The present invention belongs to the field of high-temperature sensing, and in particular, relates to a self-calibration high-temperature-resistant optical fiber temperature-vibration dual-parameter sensor.

### BACKGROUND

With the rapid development of aerospace technology, a solid rocket engine has shown a wide application prospect in many key fields of space launch, missile launch and the like due to its simple structure and high reliability. However, a combustion chamber of the solid rocket engine is often accompanied by insufficient combustion of fuel in the combustion process and generates the problems such as high-temperature and high-pressure strong vibration, resulting in irreversible damage to the structure of the engine and even serious safety accidents. At present, the traditional silicon-based electrical sensor is difficult to work normally in harsh environments such as high temperature and strong corrosion, thereby greatly limiting the application of the traditional silicon-based electrical sensor to solid rocket engine monitoring.

An optical fiber sensor has the advantages of anti-electromagnetic interference, intrinsic safety, corrosion resistance and the like, and is widely applied in extremely harsh environments. A sensor made of a fiber Bragg grating can accurately measure different physical quantities, and has the advantages of wide application range, high measurement resolution and many measurable physical quantities. The fiber Bragg grating sensor has developed rapidly in the past decades and has been applied to many fields of bridge monitoring, aerospace, petrochemical industry and the like. In the practical application process, temperature and vibration serve as two important physical parameters, and the changes of the temperature and the vibration can directly reflect the state and safety of objects. However, the fiber Bragg grating sensor at the present stage often only can measure a single parameter at a certain point, and cannot measure dual parameters such as the temperature and vibration at the same time. This limitation greatly limits the application range of the fiber Bragg grating sensor in complex environments, so that it is necessary to use a plurality of sensors to respectively perform measurement when temperature and vibration are required to be monitored at the same time. Therefore, the complexity and cost of a system are increased, and a large error may occur in the measurement result due to the mutual influence among the sensors.

In addition, generally, a fiber grating vibration-measuring sensor has the advantages of high stability, high consistency and the like, but has the problems such as high cross sensitivity and thermal mismatch at the position where the fiber grating vibration-measuring sensor is connected to a cantilever beam at high temperature; while a Fabry-Perot cavity vibration-measuring sensor has poor stability and consistency, but has low cross sensitivity, almost does not have the problem of thermal mismatch, and has higher temperature resistance.

### SUMMARY

To overcome the problem in the prior art that it is difficult for an optical fiber sensor to synchronously and accurately acquire a temperature and a vibration signal in high-temperature harsh environments, the present invention provides a self-calibration high-temperature-resistant optical fiber temperature-vibration dual-parameter sensor, so as to accurately measure the temperature and the vibration signal in harsh environments such as high temperature and strong vibration.

To solve the above technical problem, the present invention adopts the following technical solution: a self-calibration high-temperature-resistant optical fiber temperature-vibration dual-parameter sensor includes: a packaging base, a packaging cover plate, an optical fiber, a fiber Bragg grating and a sensitive diaphragm;

the packaging cover plate is fixedly connected to the packaging base, a first diaphragm groove is formed at the top of the packaging base, a second diaphragm groove is formed at the bottom of the packaging cover plate, and the first diaphragm groove and the second diaphragm groove are arranged oppositely to form a vibration space of the sensitive diaphragm; a central through hole located at the center of the second diaphragm is formed in the packaging cover plate;

the sensitive diaphragm includes a support, a cantilever beam and a mass block, the support is fixedly connected to the packaging cover plate, the mass block is arranged in the vibration space, a first Bragg grating and a second Bragg grating with different central wavelengths are arranged on the fiber Bragg grating, the first Bragg grating is fixed on the packaging cover plate, and the second Bragg grating is fixedly arranged on the sensitive diaphragm;

an end of the optical fiber is fixedly arranged in the central through hole and packaged by the packaging sleeve fixed at the top of the packaging cover plate; and an end face of the optical fiber and the sensitive diaphragm form a resonant cavity.

The self-calibration high-temperature-resistant optical fiber temperature-vibration dual-parameter sensor further includes a hollow tube, where an end of the optical fiber is fixed in the hollow tube through a high-temperature inorganic adhesive; and the hollow tube is fixed in the central through hole of the packaging cover plate through the high-temperature inorganic adhesive.

The packaging base, the packaging cover plate and the packaging sleeve are made of stainless steel; and the optical fiber, the optical Bragg grating, the sensitive diaphragm and the hollow tube are made of sapphire.

The self-calibration high-temperature-resistant optical fiber temperature-vibration dual-parameter sensor further includes a packaging substrate, where the packaging substrate is fixed at the bottom of the packaging base and is fixedly connected to the packaging base and the packaging cover plate through a bolt, and a mounting threaded hole for connecting a test part is formed at the bottom center of the packaging substrate.

The first Bragg grating has a wavelength of1545 nm, the second Bragg grating has a wavelength of1550 nm, the first Bragg grating is fixed to the sensitive diaphragm through a high-temperature inorganic adhesive, and the second Bragg grating is fixed to the packaging cover plate through the high-temperature inorganic adhesive.

A spherical optical fiber portion is arranged at a tail end of the optical Bragg grating located in the vibration space.

The sensitive diaphragm is of a single cantilever beam structure, a recessed groove connected to the second diaphragm groove is further formed at the bottom of the packaging cover plate, and the recessed groove is used for the support to be fixedly arranged so as to fix the sensitive diaphragm.

The mass block, the first diaphragm groove and the second diaphragm groove are all square, the support is of an isosceles triangle, one end of the cantilever beam is connected to a vertex angle of the support, and the other end of the cantilever beam is connected to one corner of the mass block.

A plurality of fourth threaded holes are formed in the packaging cover plate, the packaging cover plate is fixedly connected to the packaging base through bolts arranged in the fourth threaded holes, a plurality of fifth through holes are formed in the packaging sleeve, and the packaging sleeve is fixedly connected to the packaging cover plate and the packaging base through bolts arranged in the fifth through holes.

The self-calibration high-temperature-resistant optical fiber temperature-vibration dual-parameter sensor further includes a first optical fiber armored tube and a second optical fiber armored tube;

the first optical fiber armored tube is arranged on the packaging sleeve, a sixth threaded hole is formed in the packaging sleeve, the sixth threaded hole is used for a bolt to be arranged so as to fix the first optical fiber armored tube, and the first optical fiber armored tube is used to protect the optical fiber;

the second optical fiber armored tube is arranged between the packaging base and the packaging cover plate, a fifth threaded hole is formed in the packaging cover plate, the fifth threaded hole is used for a bolt to be arranged so as to fix the second optical fiber armored tube, and the second optical fiber armored tube is used to protect the fiber Bragg grating.

Compared with the prior art, the present invention has the following beneficial effects:

1. The present invention provides a self-calibration high-temperature-resistant optical fiber temperature-vibration dual-parameter sensor, which adopts two groups of Bragg gratings with different central wavelengths to achieve dual-parameter measurement of temperature and vibration, where the first Bragg grating is fixed on a surface of the packaging cover plate and is only sensitive to temperature, and the actual temperature change is detected by observing a drift quantity of the central wavelength; the second Bragg grating is fixed on a surface of the sapphire sensitive diaphragm and is sensitive to vibration and temperature, and the actual temperature and vibration superposed change is detected by measuring a drift quantity of the central wavelength; and the drift quantity of the central wavelength of the second Bragg grating is calibrated by using the drift quantity of the central wavelength of the first Bragg grating, so that the influence of the temperature change on the central wavelength of the second Bragg grating is eliminated, the magnitudes of the temperature and the vibration signal in the environment can be calculated at the same time, and the consistency of the measured data is high.

2. Furthermore, the sensor provided by the present invention is further provided with a vibration-measuring sensor formed by a Fabry-Perot cavity, a Fabry-Perot resonant cavity is formed between a sapphire optical fiber and a sapphire sensitive diaphragm, and the magnitude of the vibration signal can be obtained by an interference light signal output by a demodulation cavity; and according to the present invention, a vibration signal of a same sensitive unit is measured through the fiber grating and the Fabry-Perot cavity at the same time, and vibration is represented by two vibration signals at the same time, so that the error caused by the contingency of single data can be reduced, thereby solving the problems of high cross sensitivity of the fiber grating vibration-measuring sensor and thermal mismatch at high temperature as well as the problem that the Fabry-Perot cavity vibration-measuring sensor has poor stability and consistency, and improving the accuracy of the measured data through self-calibration. Specifically, the more accurate measurement result can be obtained by averaging the two signals.

3. In the present invention, in the sensor, a packaging shell is formed by the packaging base, the packaging cover plate and the packaging sleeve, and the packaging shell is made of a 310S stainless steel material, thereby achieving full rigid connection among the packages, ensuring the stability of an optical sensing signal of the sensor at different temperatures and vibrations, and improving the test accuracy of the sensor in the high-temperature environment. Moreover, a working area of the sensor is completely formed by a sapphire material, forming homogeneous integration of the sapphire material, so that stable sensing performance can be achieved in the high-temperature environment and the thermal effect mismatch problem due to different thermal expansion coefficients of the material can be avoided.

In conclusion, the present invention provides a temperature and vibration dual-parameter integrated optical fiber sensor, so that the temperature and the vibration signal can be monitored synchronously. Furthermore, the vibration signal of the same sensitive unit is measured through the Fabry-Perot cavity at the same time, so that the vibration signal can be self-calibrated, the consistency and accuracy of the measured data can be improved, and the working temperature limitation of the traditional sensor is broken through, thereby synchronously acquiring the temperature and the vibration signal of a combustion field of the solid rocket engine, widening the working frequency band, and having a practical application value in the high-temperature and strong-vibration environment in the fields of aerospace, missile launch, nondestructive testing and the like.

### BRIEF DESCRIPTION OF THE DRAWINGS

FIG. 1 is a schematic sectional view of a high-temperature-resistant optical fiber temperature-vibration dual-parameter sensor with a self-calibration function according to an embodiment of the present invention;

FIG. 2 is a schematic diagram of a three-dimensional structure of a high-temperature-resistant optical fiber temperature-vibration dual-parameter sensor with a self-calibration function according to an embodiment of the present invention;

FIG. 3 is a schematic diagram of three-dimensional assembling of a packaging cover plate, a sapphire sensitive diaphragm and a sapphire Bragg grating according to an embodiment of the present invention;

FIG. 4 is a schematic diagram of a sectional structure of a packaging substrate according to an embodiment of the present invention;

FIG. 5 is a schematic diagram of a three-dimensional structure of a packaging base according to an embodiment of the present invention;

FIG. 6 is a schematic diagram of a three-dimensional structure of a packaging cover plate according to an embodiment of the present invention;

FIG. 7 is a schematic diagram of a three-dimensional structure of a packaging sleeve according to an embodiment of the present invention;

FIG. 8 is a schematic diagram of a three-dimensional structure of a sapphire sensitive diaphragm according to an embodiment of the present invention;

FIG. 9 is a schematic diagram of a reflection spectrum of a fiber Bragg grating according to an embodiment of the present invention;

FIG. 10 is a schematic diagram of a reflection spectrum of a Fabry-Perot cavity according to an embodiment of the present invention.

In the drawings: 2-packaging base; 3-packaging cover plate; 4-packaging sleeve; 5-first optical fiber armored tube; 6-optical fiber; 7-second optical fiber armored tube; 8-fiber Bragg gating; 9-hollow tube; 10-sensitive diaphragm; 11-packaging substrate; 21-second threaded hole; 22-first long groove; 23-first diaphragm groove; 24-fifth through hole; 25-first through hole; 31-first threaded hole; 32-fourth through hole; 33-fourth threaded hole; 34-third through hole; 35-second long groove; 36-third long groove; 37-recessed groove; 38-second diaphragm groove; 39-central through hole; 41-second through hole; 42-circular groove; 43-third threaded hole; 81-first Bragg grating; 82-second Bragg grating; 83-spherical optical fiber; 101-support; 102-single cantilever beam; 103-mass block; 111-mounting threaded hole; 112-fifth threaded hole.

### DETAILED DESCRIPTION OF THE EMBODIMENTS

To make the objectives, technical solutions and advantages of the embodiments of the present invention clearer, the technical solutions in the embodiments of the present invention will be described clearly and completely below. Obviously, the described embodiments are some rather than all of the embodiments of the present invention. Based on the embodiments of the present invention, all other embodiments obtained by those of ordinary skill in the art without creative efforts shall fall within the protection scope of the present invention.

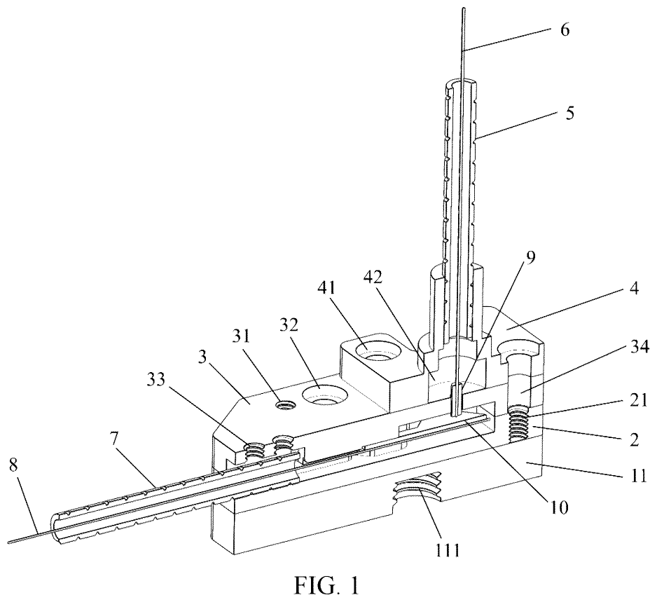

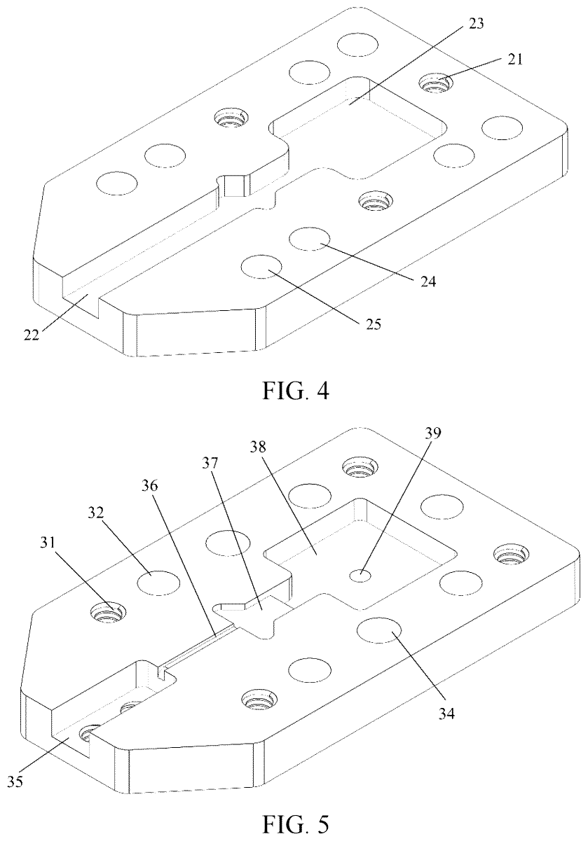

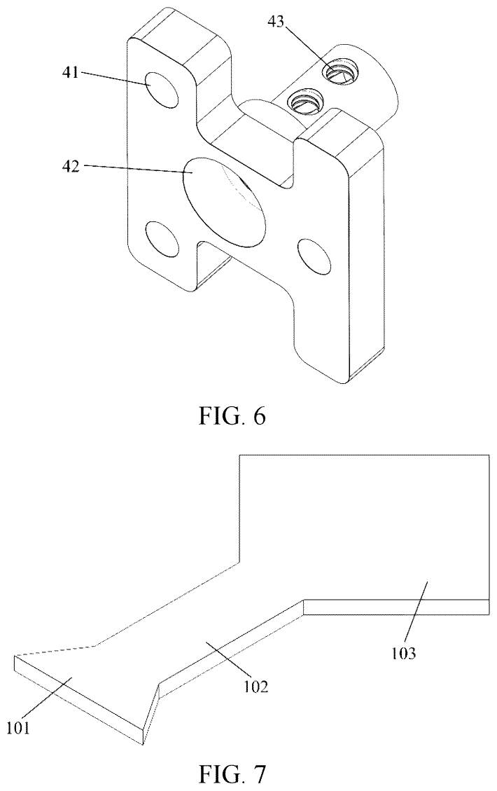

As shown in FIG. 1 to FIG. 8, embodiments of the present invention provide a high-temperature-resistant optical fiber temperature-vibration dual-parameter sensor with a self-calibration function, including a packaging base 2, a packaging cover plate 3, a packaging sleeve 4, an optical fiber 6, a fiber Bragg gating 8 and a sensitive diaphragm 10, where

the packaging cover plate 3 is fixedly connected to the packaging base 2, a first diaphragm groove 23 is formed at the top of the packaging base 2 through etching, a second diaphragm groove 38 is formed at the bottom of the packaging cover plate 3 through etching, and the first diaphragm groove 23 and the second diaphragm groove 38 are arranged oppositely to form a vibration space of the sensitive diaphragm 10; a central through hole 39 located at the center of the second diaphragm 38 is formed in the packaging cover plate 3;

the sensitive diaphragm 10 includes a support 101, a cantilever beam 102 and a mass block 103, the support 101 is fixedly connected to the packaging cover plate 3, the mass block 103 is arranged in the vibration space, a first Bragg grating 81 and a second Bragg grating 82 with different central wavelengths are arranged on the fiber Bragg grating 8, the first Bragg grating 81 is fixed on the packaging cover plate 3, and the second Bragg grating 82 is fixedly arranged on the sensitive diaphragm 10;

an end of the optical fiber 6 is fixedly arranged in the central through hole 39 and packaged by the packaging sleeve 4 fixed at the top of the packaging cover plate 3; and an end face of the optical fiber 6 and the sensitive diaphragm 10 form a resonant cavity.

Further, the self-calibration high-temperature-resistant optical fiber temperature-vibration dual-parameter sensor of this embodiment further includes a hollow tube 9, where an end of the optical fiber 6 is fixed in the hollow tube 9 through a high-temperature inorganic adhesive; and the hollow tube 9 is fixed in the central through hole 39 of the packaging cover plate 3 through the high-temperature inorganic adhesive.

In this embodiment, the packaging base 2, the packaging cover plate 3 and the packaging sleeve 4 are made of stainless steel; and the optical fiber 6, the optical Bragg grating 8 and the sensitive diaphragm 10 are made of sapphire.

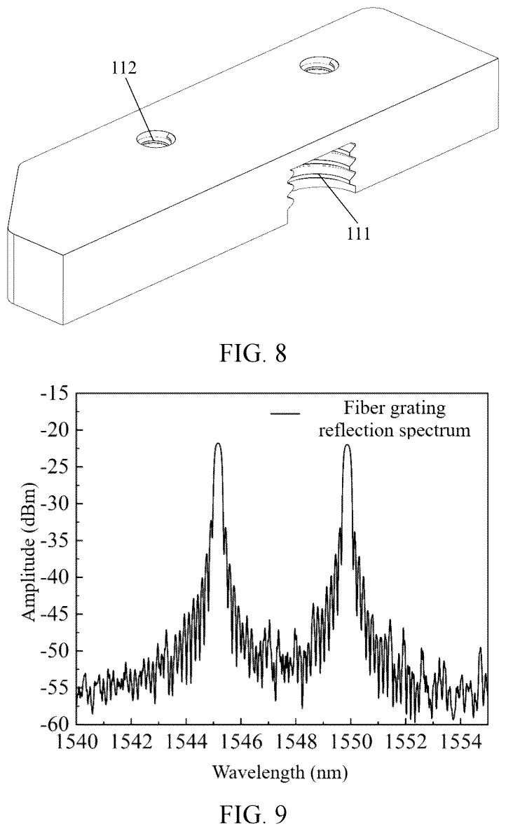

Further, the self-calibration high-temperature-resistant optical fiber temperature-vibration dual-parameter sensor of this embodiment further includes a packaging substrate 11, where the packaging substrate 11 is fixed at the bottom of the packaging base 2, and the packaging base 2 and the packaging cover plate 3 are fixedly arranged on the packaging substrate 11 through a bolt. As shown in FIG. 8, a mounting threaded hole 111 for connecting a test part is formed at the bottom center of the packaging substrate 11. The packaging substrate 11 is arranged, so that when the sensor is mounted, the packaging substrate 11 can be connected to a part to be tested through a screw in the mounting threaded hole 111, and then passes through the packaging cover plate 3 and the packaging base 2 through the bolt to be connected to the packaging substrate 11, thereby fixing the sensor and avoiding damage to the optical fiber caused by the rotation process when the sensor is mounted.

Specifically, in this embodiment, the first Bragg grating 81 has a wavelength of 1545 nm, the second Bragg grating 82 has a wavelength of 1550 nm, the first Bragg grating 81 is fixed to the sensitive diaphragm 10 through a high-temperature inorganic adhesive, and the second Bragg grating 82 is fixed to the packaging cover plate 3 through the high-temperature inorganic adhesive. Specifically, the first Bragg grating 81 and the second Bragg grating 82 can be formed by writing in the optical fiber through a femtosecond laser. The first Bragg grating 81 is stuck on a surface of the packaging cover plate 3 and only sensitive to the temperature, and the actual temperature change is detected by observing a drift quantity of the central wavelength; meanwhile, the second Bragg grating 82 is stuck on the sapphire sensitive diaphragm 10 and sensitive to the vibration and the temperature, and the actual temperature and vibration superposed change is detected by observing a drift quantity of the central wavelength; and the second Bragg grating 82 is compensated by using the first Bragg grating 81, so that the magnitudes of the temperature and the vibration signal in the environment can be calculated at the same time.

Further, in this embodiment, a spherical optical fiber portion 83 is arranged at a tail end of the optical Bragg grating 8 located in the vibration space. Specifically, the tail end of the optical Bragg grating 8 is subjected to ball burning by a fiber fusion splicer to form the Spherical fiber end face 83. Forming the Spherical fiber end face 83 through ball burning can effectively increase return loss and increase the spectral signal-to-noise ratio.

Further, as shown in FIG. 3 and FIG. 7, in this embodiment, the sensitive diaphragm 10 is of a single cantilever beam structure, the support 101 is connected to the mass block 103 through a cantilever beam 102, as shown in FIG. 5, a recessed groove 37 connected to the second diaphragm 38 is further arranged at the bottom of the packaging cover plate 3, and the recessed groove 37 is used for the support 101 to be fixedly arranged, so that the sensitive diaphragm 10 is fixed. The depth of the recessed groove 37 is less than that of the second diaphragm groove 38, then a gap between the second diaphragm groove 38 and the mass block 103 forms an upward vibration space of the mass block 103 of the sensitive diaphragm 10. In addition, a gap between the first diaphragm groove 23 at the top of the packaging base 2 and the mass block 103 forms a downward vibration space of the mass block 103 of the sensitive diaphragm 10.

Further, in this embodiment, the mass block 103, the first diaphragm groove 23 and the second diaphragm groove 38 are all square, the support 101 is of an isosceles triangle, one end of the cantilever beam 102 is connected to a vertex angle of the support 101, and the other end of the cantilever beam is connected to one corner of the mass block 103. In addition, the mass block 103, the first diaphragm groove 23 and the second diaphragm groove 38 are staggered at 45°, and the side length of the first diaphragm groove 23 and the second diaphragm groove 38 are greater than the diagonal length of the square mass block 103.

Further, in this embodiment, a plurality of first threaded holes 31 are formed in the packaging cover plate 3, the packaging base 2 is provided with a first through hole 25 at the position corresponding to the first threaded holes 31, and the packaging base 2 is fixedly connected to the packaging cover plate 3 through bolts arranged in the first through hole 25 and the first threaded holes 31; and a plurality of second through holes 41 are formed in the packaging sleeve 4, the packaging cover plate 3 is provided with a third through hole 34 at the position corresponding to the second through hole 41, the packaging base 2 is provided with a second threaded hole 21 at the position corresponding to the second through hole 41, and the packaging sleeve 4 is fixedly connected to the packaging cover plate 3 and the packaging base 2 through bolts arranged in the second through holes 41, the third through hole 34 and the second threaded hole 21.

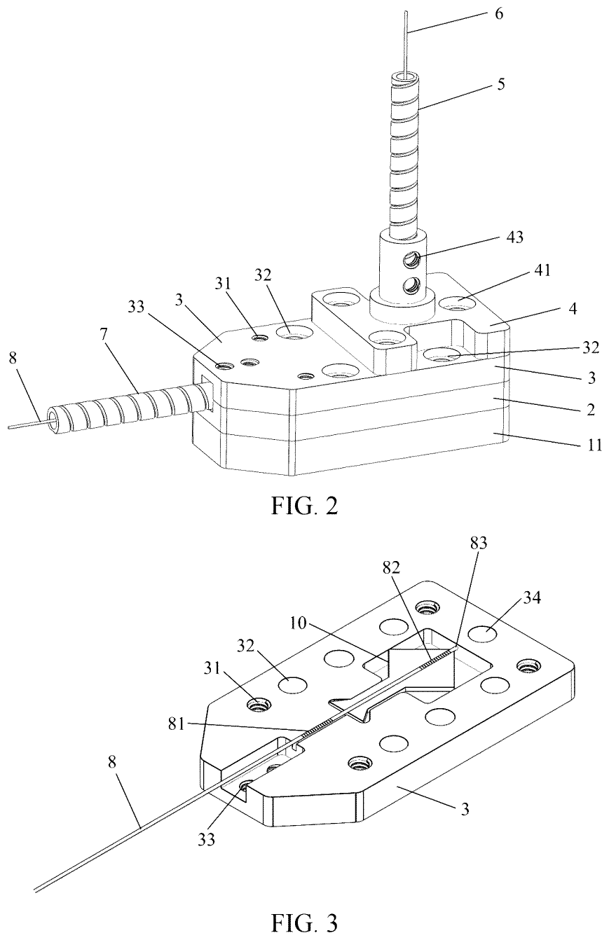

Further, as shown in FIG. 1 to FIG. 2, the self-calibration high-temperature-resistant optical fiber temperature-vibration dual-parameter sensor of this embodiment further includes a first optical fiber armored tube 5 and a second optical fiber armored tube 7, where the first optical fiber armored tube 5 is arranged on the packaging sleeve 4, two third threaded holes 43 are formed in the packaging sleeve 4, the third threaded holes 43 are used for a bolt to be arranged so as to fix the first optical fiber armored tube 5, and the first optical fiber armored tube 5 is used to protect the optical fiber 6; and the second optical fiber armored tube 7 is arranged between the packaging base 2 and the packaging cover plate 3, two fourth threaded holes 33 are formed in the packaging cover plate 3, the fourth threaded holes 33 are used for the bolt to be arranged so as to fix the second optical fiber armored tube 7, and the second optical fiber armored tube 7 is used to protect the fiber Bragg grating 8.

Further, in this embodiment, a plurality of fourth through holes 32 are further formed in the packaging cover plate 3, the packaging base 2 is provided with a fifth through hole 24 at the position corresponding to the fourth through holes 32, and the packaging substrate 11 is provided with a fifth threaded hole 112 at the position corresponding to the fourth through holes 32, then the packaging cover plate 3, the packaging base 2 and the packaging substrate 11 are fixedly connected through bolts arranged in the fourth through holes 32, the fifth through hole 24 and the fifth threaded hole 112.

Further, in this embodiment, the packaging base 2 and the packaging cover plate 3 are respectively provided with a first long groove 22 and a second long groove 35 at the positions corresponding to the second optical fiber armored tube 7, and the first long groove 22 and the second long groove 35 form an accommodating space of the optical fiber armored tube 7. Further, in addition, a third long groove 36 is formed between the second long groove 35 and the recessed groove 37, and the third long groove 36 is used to arrange an optical fiber section where the first Bragg grating of the fiber Bragg grating 8 is located.

Further, in this embodiment, the packaging sleeve 4 includes a flat plate portion and a top protrusion, the second through holes 41 are formed in the flat plate portion, the third threaded holes 43 are formed in the top protrusion, and a circular groove 42 is formed in the top protrusion and used to accommodate the hollow tube 9.

In addition, the embodiments of the present invention further provide an assembling method for a high-temperature-resistant optical fiber temperature-vibration dual-parameter sensor with a self-calibration function, including the following steps:
Step S1: a pre-cleaned sensitive diaphragm 10 is placed on a packaging cover plate 3, a high-temperature inorganic adhesive is uniformly coated between the packaging cover plate 3 and the sensitive diaphragm 10, and the high-temperature inorganic adhesive is cured by baking in a bake oven.
Step S2: a fiber Bragg grating 8 inscribed by femtosecond laser is placed on the packaging cover plate 3 and the sapphire sensitive diaphragm 10, the position where the fiber Bragg grating 8 is in contact with the packaging cover plate 3 and the sensitive diaphragm 10 is uniformly coated with the high-temperature inorganic adhesive by a full-sticking method, and the high-temperature inorganic adhesive is cured by baking in the bake oven.
Step S3: the packaging cover plate 3 and the packaging base 2 are tightly connected through a screw.
Step S4: the head of an optical fiber 6 wrapped by a hollow tube 9 extends into a central through hole 39 of the packaging cover plate 3, the position where the packaging cover plate 3 is connected to the sapphire hollow tube 9 is coated with the high-temperature inorganic adhesive, and the high-temperature inorganic adhesive is cured by baking in the bake oven.
Step S5: the packaging sleeve 4, the packaging cover plate 3 and the packaging base 2 are tightly connected through screws.
Step S6: a packaging substrate is arranged on a part to be tested by a screw, and then the screw passes through the packaging cover plate 3 and the packaging base 2 to be tightly connected to the packaging substrate 11.

Specifically, in this embodiment, step S3 further includes the following steps:
a second optical fiber armored tube 7 passes through an outer side of the fiber Bragg grating 8 and extends into a first long groove 22 and a second long groove 35 of the packaging cover plate 3 and the packaging base 2, and the second optical fiber armored tube 7 is fixed through screws arranged in a plurality of fourth threaded holes 33.

Step S5 further includes the following steps:
a first optical fiber armored tube 5 passes through an outer side of the optical fiber 6 and extends into the packaging sleeve 4, and the first optical fiber armored tube 5 is fixed through screws arranged in a plurality of third threaded holes 43.

In this embodiment, an amplified spontaneous radiation light source enters the fiber Bragg grating 8 through an optical fiber circulator, reflected light generated by a grid region enters a spectrometer through the optical fiber circulator, the obtained spectral signal is shown in FIG. 9, and a vibration signal can be obtained by demodulating the jitter of the reflection spectrum of the second Bragg grating 82 near the central wavelength.

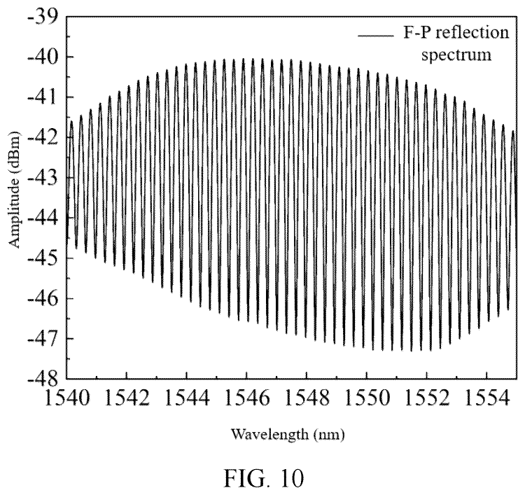

In this embodiment, the amplified spontaneous radiation light source enters the optical fiber 6 through the optical fiber circulator, multi-beam interference occurs between an end face of the optical fiber 6 and a surface of the sensitive diaphragm 10, interference light enters the spectrometer through the optical fiber circulator, the obtained spectral signal is shown in FIG. 10, and the vibration signal can be demodulated by acquiring the change of the free spectral region of the spectrum with time.

In conclusion, the present invention provides a self-calibration high-temperature-resistant optical fiber temperature-vibration dual-parameter sensor; synchronous dual-parameter measurement of the temperature and the vibration can be achieved by observing the drift of the central wavelength of the Bragg grating with different central wavelengths; furthermore, in the present invention, a Fabry-Perot resonant cavity is formed through the sensitive diaphragm and the sapphire optical fiber, and the vibration signal is calibrated, so that the test range and accuracy are improved; and in addition, in the present invention, the packaging shell is rigidly connected through stainless steel, thereby ensuring the stability of the optical sensing signal of the sensor at different temperatures and vibrations, improving the test accuracy of the sensor in the high-temperature environment, breaking through the working temperature limitation of the traditional sensor, widening the working frequency band of the sensor, and having a practical application value in the high-temperature and strong-vibration environment in the fields of aerospace, missile launch, nondestructive testing and the like.

Finally, it should be noted that the foregoing embodiments are merely intended for describing the technical solutions of the present invention, but not for limiting the present invention. Although the present invention is described in detail with reference to the foregoing embodiments, those of ordinary skill in the art should understand that they may still make modifications to the technical solutions described in the foregoing embodiments or make equivalent replacements to some or all technical features thereof, without departing from the scope of the technical solutions of the embodiments of the present invention.

1. A self-calibration high-temperature-resistant optical fiber temperature-vibration dual-parameter sensor, comprising: a packaging base (2), a packaging cover plate (3), a packaging sleeve (4), an optical fiber (6), a fiber Bragg grating (8) and a sensitive diaphragm (10), wherein
the packaging cover plate (3) is fixedly connected to the packaging base (2), a first diaphragm groove (23) is formed at the top of the packaging base (2), a second diaphragm groove (38) is formed at the bottom of the packaging cover plate (3), and the first diaphragm groove (23) and the second diaphragm groove (38) are arranged oppositely to form a vibration space of the sensitive diaphragm (10); a central through hole (39) located at the center of the second diaphragm (38) is formed in the packaging cover plate (3);
the sensitive diaphragm (10) comprises a support (101), a cantilever beam (102) and a mass block (103), the support (101) is fixedly connected to the packaging cover plate (3), the mass block (103) is arranged in the vibration space, a first Bragg grating (81) and a second Bragg grating (82) with different central wavelengths are arranged on the fiber Bragg grating (8), the first Bragg grating (81) is fixed on the packaging cover plate (3), and the second Bragg grating (82) is fixedly arranged on the sensitive diaphragm (10);
an end of the optical fiber (6) is fixedly arranged in the central through hole (39) and packaged by the packaging sleeve (4) fixed at the top of the packaging cover plate (3); and an end face of the optical fiber (6) and the sensitive diaphragm (10) form a resonant cavity.

2. The self-calibration high-temperature-resistant optical fiber temperature-vibration dual-parameter sensor according to claim 1, further comprising a hollow tube (9), wherein an end of the optical fiber (6) is fixed in the hollow tube (9) through a high-temperature inorganic adhesive;
and the hollow tube (9) is fixed in the central through hole (39) of the packaging cover plate (3) through the high-temperature inorganic adhesive.

3. The self-calibration high-temperature-resistant optical fiber temperature-vibration dual-parameter sensor according to claim 2, wherein the packaging base (2), the packaging cover plate (3) and the packaging sleeve (4) are made of stainless steel; and the optical fiber (6), the optical Bragg grating (8), the sensitive diaphragm (10) and the hollow tube (9) are made of sapphire.

4. The self-calibration high-temperature-resistant optical fiber temperature-vibration dual-parameter sensor according to claim 1, further comprising a packaging substrate (11), wherein the packaging substrate (11) is fixed at the bottom of the packaging base (2) and is fixedly connected to the packaging base (2) and the packaging cover plate (3) through a bolt, and a mounting threaded hole (111) for connecting a test part is formed at the bottom center of the packaging substrate (11).

5. The self-calibration high-temperature-resistant optical fiber temperature-vibration dual-parameter sensor according to claim 1, wherein the first Bragg grating (81) has a wavelength of 1545 nm, the second Bragg grating (82) has a wavelength of 1550 nm, the first Bragg grating (81) is fixed to the sensitive diaphragm (10) through a high-temperature inorganic adhesive, and the second Bragg grating (82) is fixed to the packaging cover plate (3) through the high-temperature inorganic adhesive.

6. The self-calibration high-temperature-resistant optical fiber temperature-vibration dual-parameter sensor according to claim 1, wherein a spherical optical fiber portion (83) is arranged at a tail end of the optical Bragg grating (8) located in the vibration space.

7. The self-calibration high-temperature-resistant optical fiber temperature-vibration dual-parameter sensor according to claim 1, wherein the sensitive diaphragm (10) is of a single cantilever beam structure, a recessed groove (37) connected to the second diaphragm groove (38) is further formed at the bottom of the packaging cover plate (3), and the recessed groove (37) is used for the support (101) to be fixedly arranged so as to fix the sensitive diaphragm (10).

8. The self-calibration high-temperature-resistant optical fiber temperature-vibration dual-parameter sensor according to claim 7, wherein the mass block (103), the first diaphragm groove (23) and the second diaphragm groove (38) are all square, the support (101) is of an isosceles triangle, one end of the cantilever beam (102) is connected to a vertex angle of the support (101), and the other end of the cantilever beam (102) is connected to one corner of the mass block (103).

9. The self-calibration high-temperature-resistant optical fiber temperature-vibration dual-parameter sensor according to claim 6, wherein a plurality of fourth threaded holes (31) are formed in the packaging cover plate (3), the packaging cover plate (3) is fixedly connected to the packaging base (2) through bolts arranged in the fourth threaded holes (31), a plurality of fifth through holes (41) are formed in the packaging sleeve (4), and the packaging sleeve (4) is fixedly connected to the packaging cover plate (3) and the packaging base (2) through bolts arranged in the fifth through holes (41).

10. The self-calibration high-temperature-resistant optical fiber temperature-vibration dual-parameter sensor according to claim 6, further comprising a first optical fiber armored tube (5) and a second optical fiber armored tube (7), wherein
the first optical fiber armored tube (5) is arranged on the packaging sleeve (4), a sixth threaded hole (43) is formed in the packaging sleeve (4), the sixth threaded hole (43) is used for a bolt to be arranged so as to fix the first optical fiber armored tube (5), and the first optical fiber armored tube (5) is used to protect the optical fiber (6); and
the second optical fiber armored tube (7) is arranged between the packaging base (2) and the packaging cover plate (3), a fifth threaded hole (33) is formed in the packaging cover plate (3), the fifth threaded hole (33) is used for a bolt to be arranged so as to fix the second optical fiber armored tube (7), and the second optical fiber armored tube (7) is used to protect the fiber Bragg grating (8).
